(19) United States
(12) Patent Application Publication
(10) Pub. No.: US 2026/0218633 A1
(43) Pub. Date: Jul. 30, 2026

(54) ENGINE BRAKING DEVICE WITH RETURNING AND LIMITING FUNCTIONS AND ENGINE

(71) Applicant: Zhejiang Liming Intelligent Manufacturing Co., Ltd., Zhoushan (CN)

(72) Inventors: Zhenhuan YU, Zhoushan (CN); Xianting XU, Zhoushan (CN); Quanzhong WU, Zhoushan (CN)

(21) Appl. No.: 19/629,390

(22) Filed: Mar. 26, 2026

Related U.S. Application Data
(63) Continuation of application No. PCT/CN2025/087232, filed on Apr. 3, 2025.

(30) Foreign Application Priority Data
Dec. 12, 2024 (CN) 202411829820.1

(51) Int. Cl. F01L 13/06; F01L 1/18; F01L 1/46

(52) U.S. Cl. CPC F01L 13/06; F01L 1/18; F01L 1/462

(57) ABSTRACT

The present invention provides an engine braking device with returning and limiting functions and an engine. The engine braking device includes: a camshaft including an auxiliary cam; a brake rocker arm and a rocker arm shaft that mate via a shaft hole; a rocker arm support base provided with a first connecting portion; a return spring bracket with an end connected to a first connecting portion; and a first elastic member with both ends sandwiched between the other end of the return spring bracket and the butting platform. According to the present invention, the overall size of the engine braking device in a vertical direction is reduced, achieving a compacter structure.

### FIELD OF THE INVENTION

The present invention belongs to the technical field of automotive parts, and relates to an engine braking device, in particular to an engine braking device with returning and limiting functions and an engine.

### BACKGROUND OF THE INVENTION

An engine braking technique refers to the process during which, while a vehicle is in operation, a driver releases an accelerator pedal and disengages a clutch to apply, to drive wheels, a braking force that is created by means of compression resistance generated during an engine compression stroke, as well as intake and exhaust resistance and friction forces, thereby slowing down the vehicle. The application of the engine braking technique effectively reduces the frequency of using service brakes. When the vehicle travels down long slopes or on rugged mountain roads or other steep roads, engine braking can prevent brake friction pads from overheating due to prolonged use of the brakes, which could otherwise lead to a decrease in braking force or even loss of effective braking.

A patent application (CN202110941484.X) discloses an energy-saving and consumption-reducing engine braking device, which includes a movable unit and a control mechanism, wherein the movable unit is movably arranged at the rear end of an auxiliary rocker arm, and corresponds to an auxiliary cam; and the control mechanism can drive the movable unit to act, so that the movable unit has a first position in contact with the auxiliary cam and a second position separated from the auxiliary cam.

Although the engine braking device described above achieves the effect of energy saving and consumption reduction, the overall size of the engine braking device in a vertical direction is relatively large, which may lead to collisions with an engine cover after the engine braking device is installed, compromising an engine braking effect.

### SUMMARY OF THE INVENTION

In view of the above-mentioned problems existing in the prior art, an object of the present invention is to provide an engine braking device with an effectively reduced size in a vertical direction and a secured braking effect.

The object of the present invention can be achieved with a technical solution as follows: an engine braking device with returning and limiting functions includes:
a camshaft including an auxiliary cam, an outer contour of the auxiliary cam being provided with a non-working surface and a working surface, wherein a distance between the working surface and a base circle center of the auxiliary cam is greater than a distance between the non-working surface and the base circle center of the auxiliary cam;
a brake rocker arm and a rocker arm shaft that mate via a shaft hole, the brake rocker arm being swingable back and forth around the rocker arm shaft, and an axis direction of the rocker arm shaft and an axis direction of the camshaft being parallel to each other, wherein a lateral portion of the brake rocker arm extends in a horizontal direction to form a butting platform, an outer surface of the rocker arm shaft is provided with a limiting recess, both sides of the limiting recess are provided with a first butting surface A and a first butting surface B, respectively, the brake rocker arm is provided with a limiting protrusion in concave-convex mating with the limiting recess, both sides of the limiting protrusion are provided with a second butting surface A and a second butting surface B, respectively, and a relative distance between the second butting surface A and the second butting surface B is less than a relative distance between the first butting surface A and the first butting surface B;
a rocker arm support base, wherein both ends of the rocker arm support base are mated with a shaft hole of the camshaft and the shaft hole of the rocker arm shaft, respectively, and an end of the rocker arm support base mated with the shaft hole of the camshaft is provided with a first connecting portion;
a return spring bracket with an end connected to the first connecting portion via a fastener or connected to a second connecting portion on the rocker arm shaft, wherein a horizontal height of the first connecting portion and a horizontal height of the second connecting portion are both higher than a horizontal height of the butting platform, and a horizontal height of the return spring bracket is lower than a horizontal height of an upper surface of the brake rocker arm;
a slidable unit slidably connected to an end of the brake rocker arm corresponding to the auxiliary cam, the slidable unit being provided with a wheel, wherein an axis direction of the wheel and the axis direction of the camshaft are parallel to each other; and
a first elastic member with both ends sandwiched between the other end of the return spring bracket and the butting platform, wherein an axis of the first elastic member is biased to a side of a connecting line between a circle center of the auxiliary cam and a circle center of the wheel, and the first elastic member is located between the wheel and the rocker arm shaft;
wherein when an engine works normally, a gap exists between the wheel and the working surface of the auxiliary cam, the first butting surface A and the second butting surface A butt against each other, and the first elastic member is in an energy storage state; and
when the engine is in a braked state, the wheel contacts the outer contour of the auxiliary cam, and as the working surface and the non-working surface on the auxiliary cam alternately contact the wheel, the brake rocker arm is caused to swing back and forth around the rocker arm shaft, and the limiting protrusion is caused to swing back and forth inside the limiting recess.

In the engine braking device with returning and limiting functions described above, a position for the concave-convex mating between the limiting recess and the limiting protrusion is on a right half side of the rocker arm shaft, and wherein an extension line of an axis of the limiting protrusion passes through a circle center of a cross section of the rocker arm shaft where the limiting protrusion is located.

In the engine braking device with returning and limiting functions described above, the limiting recess is a limiting hole, the limiting protrusion is a limiting pin threaded to the brake rocker arm, and an end of the limiting pin passes through the limiting hole and extends into the rocker arm shaft, wherein an aperture of the limiting hole is greater than a diameter of the end of the limiting pin in inserted mating with the limiting hole, and the first butting surface A, the first butting surface B, the second butting surface A and the second butting surface B are each provided in form of an arc-shaped surface.

In the engine braking device with returning and limiting functions described above, the return spring bracket is provided in a plate-like form, one end of the return spring bracket is provided with a first mounting hole that is in inserted mating with the fastener and serves to mount the return spring bracket on the rocker arm support base, and the other end of the return spring bracket is provided with a boss, wherein interference nested fit is formed between the boss and the first elastic member, and an end of the first elastic member mating the boss butts against a surface of the return spring bracket.

In the engine braking device with returning and limiting functions described above, the return spring bracket is provided in a plate-like form, one end of the return spring bracket is provided with a first mounting hole that is in inserted mating with the fastener and serves to mount the return spring bracket on the rocker arm shaft, and the other end of the return spring bracket is provided with a boss, wherein interference nested fit is formed between the boss and the first elastic member, and an end of the first elastic member mating the boss butts against a surface of the return spring bracket.

In the engine braking device with returning and limiting functions described above, the first connecting portion includes a connecting column, and a connecting hole is provided in the connecting column, wherein the first mounting hole in the return spring bracket and the connecting hole are connected to each other via a fastener.

In the engine braking device with returning and limiting functions described above, the second connecting portion includes a first mounting plane that is formed by downwards sinking a side of the rocker arm shaft facing the return spring bracket, and a horizontal height of the first mounting plane is higher than a horizontal height of the butting platform, wherein the first mounting plane is provided with a second mounting hole connected to the return spring bracket.

In the engine braking device with returning and limiting functions described above, both ends of the rocker arm shaft in the axis direction thereof are each provided with a first mounting plane, and the first mounting planes at both ends of the rocker arm shaft are at the same horizontal plane.

In the engine braking device with returning and limiting functions described above, the butting platform is provided with a positioning portion, which is in nested fit with the first elastic member and by which a radial degree of freedom of the first elastic member is defined, wherein the positioning portion is a concave cavity or a positioning projection; when the positioning portion is the concave cavity, an end of the first elastic member is nested in the concave cavity and butts against a bottom of the concave cavity; and when the positioning portion is the positioning projection, an end of the first elastic member is nested in the positioning projection and butts against a surface of the butting platform.

The present invention further provides an engine braking device with returning and limiting functions, including:
a camshaft including an auxiliary cam, an outer contour of the auxiliary cam being provided with a non-working surface and a working surface, wherein a distance between the working surface and a base circle center of the auxiliary cam is greater than a distance between the non-working surface and the base circle center of the auxiliary cam;
a brake rocker arm and a rocker arm shaft that mate via a shaft hole, the brake rocker arm being swingable back and forth around the rocker arm shaft, and an axis direction of the rocker arm shaft and an axis direction of the camshaft are parallel to each other, wherein a lateral portion of the brake rocker arm extends in a horizontal direction to form a butting platform, an outer surface of the rocker arm shaft is provided with a limiting recess, both sides of the limiting recess are provided with a first butting surface A and a first butting surface B, respectively, the brake rocker arm is provided with a limiting protrusion in concave-convex mating with the limiting recess, both sides of the limiting protrusion are provided with a second butting surface A and a second butting surface B, respectively, and a relative distance between the second butting surface A and the second butting surface B is less than a relative distance between the first butting surface A and the first butting surface B;
a rocker arm support base, wherein both ends of the rocker arm support base are mated with a shaft hole of the camshaft and the shaft hole of the rocker arm shaft, respectively, and an end of the rocker arm support base mated with the shaft hole of the camshaft is provided with a first connecting portion;
a second elastic member with an end connected to the first connecting portion via a fastener or connected to a second connecting portion on the rocker arm shaft, wherein a horizontal height of the first connecting portion and a horizontal height of the second connecting portion are both lower than a horizontal height of the butting platform, and a horizontal height of an end of the second elastic member butting against the butting platform is lower than a horizontal height of an upper surface of the brake rocker arm;
a slidable unit slidably connected to an end of the brake rocker arm corresponding to the auxiliary cam, the slidable unit being provided with a wheel, wherein an axis direction of the wheel and the axis direction of the camshaft are parallel to each other; and
wherein when an engine works normally, a gap exists between the wheel and the working surface of the auxiliary cam, the first butting surface A and the second butting surface A butt against each other, and the second elastic member is in a deformation state; and
when the engine is braked during working, the wheel contacts the outer contour of the auxiliary cam, and as the working surface and the non-working surface on the auxiliary cam alternately contact the wheel, the brake rocker arm is caused to swing back and forth around the rocker arm shaft, and the limiting protrusion is caused to swing back and forth inside the limiting recess.

In the engine braking device with returning and limiting functions described above, the second elastic member is provided in form of a Z-shaped plate, and both ends of the second elastic member include a first connecting end and a second connecting end, respectively, wherein the first connecting end and the rocker arm shaft are in face-to-face contact, and are connected and fixed via a fastener, and the second connecting end and the butting platform are in face-to-face contact.

In the engine braking device with returning and limiting functions described above, the butting platform is provided with a positioning protrusion or recess, and the second connecting end of the second elastic member is provided with a corresponding positioning recess or protrusion, wherein relative slippage between the butting platform and the second connecting end of the second elastic member is defined by means of concave-convex mating between the positioning protrusion and the positioning recess.

In the engine braking device with returning and limiting functions described above, the first connecting portion includes a connecting column, and a connecting hole is provided in the connecting column, wherein a third mounting hole in the second elastic member and the connecting hole are connected to each other via a fastener.

In the engine braking device with returning and limiting functions described above, the second connecting portion includes a second mounting plane that is formed by downwards sinking a side of the rocker arm shaft facing the second elastic member, and a horizontal height of the second mounting plane is lower than a horizontal height of the butting platform, wherein the second mounting plane is provided with a fourth mounting hole connected to the second elastic member.

In the engine braking device with returning and limiting functions described above, both ends of the rocker arm shaft in the axis direction thereof are each provided with a second mounting plane, and the second mounting planes at both ends of the rocker arm shaft are at the same horizontal plane.

The present invention further provides an engine, including the engine braking device with returning and limiting functions described above.

Compared with the prior art, the present invention has the following advantages.
(1) The present invention provides an engine braking device with returning and limiting functions, the overall size of which is reduced in a vertical direction, resulting in a compacter structure. In addition, the concave-convex mating between the limiting protrusion and the limiting recess reduces frictional work and engine fuel consumption by preventing the wheel from contacting the auxiliary cam when the engine works normally, and also enables controlling of the amplitude of back-and-forth swing of the brake rocker arm when the engine is in a braked stage, thereby achieving an improved braking effect.
(2) The positioning portion arranged on the butting platform serves to keep the elastic member always moving along its axis direction during its extension or compression process, without twisting or deviation.
(3) The elastic member is provided in form of a plate-like structure in such a manner that the elastic member is in face-to-face contact with both the butting platform and the second mounting plane. In this way, the contact area is increased, resulting in improved connection firmness and service reliability of the elastic member.

### BRIEF DESCRIPTION OF THE DRAWINGS

FIG. 1 shows a schematic structural diagram of an engine braking device with returning and limiting functions according to the present invention;

FIG. 2 shows a schematic structural diagram of the engine braking device with returning and limiting functions according to the present invention when an engine works normally;

FIG. 3 shows a schematic structural diagram of the engine braking device with returning and limiting functions according to the present invention when the engine is in a braked state;

FIG. 4 shows an enlarged view of a section A in FIG. 2;

FIG. 5 shows an enlarged view of a section B in FIG. 3;

FIG. 6 shows a schematic structural diagram of a brake rocker arm according to a preferred embodiment of the present invention;

FIG. 7 shows a schematic structural diagram of a rocker arm shaft according to a preferred embodiment of the present invention;

FIG. 8 shows a schematic structural diagram of a return spring bracket according to a preferred embodiment of the present invention;

FIG. 9 shows a sectional view of the return spring bracket and a first elastic member that mate each other according to a preferred embodiment of the present invention;

FIG. 10 shows a schematic structural diagram of another embodiment of the engine braking device with returning and limiting functions according to the present invention;

FIG. 11 shows a schematic structural diagram of a rocker arm shaft shown in FIG. 10; and

FIG. 12 shows a schematic structural diagram of a second elastic member shown in FIG. 10.

In these figures, reference signs are as follows:
10, camshaft; 11, auxiliary cam; 111, non-working surface; 112, working surface;
20, brake rocker arm; 21, butting platform; 211, positioning portion; 22, limiting protrusion; 221, second butting surface A; 222, second butting surface B;
30 , rocker arm shaft; 31, limiting recess; 311, first butting surface A; 312, first butting surface B; 32, second connecting portion; 321, first mounting plane; 322, second mounting hole;
40, rocker arm support base; 41, first connecting portion; 411, connecting column; 412, connecting hole;
50, return spring bracket; 51, first mounting hole; 52, boss;
60, slidable unit; 61, wheel;
70, first elastic member;
80, second elastic member; 81, first connecting end; 82, second connecting end; 83, third mounting hole.

### DETAILED DESCRIPTION OF THE INVENTION

The following provides the specific embodiments of the present invention, and the technical solutions of the present invention are further described in combination with the accompanying drawings, but the present invention is not limited to these embodiments.

It should be noted that, in the embodiments of the present invention, all directional indications (such as up, down, left, right, front, and back) are only intended to explain the relative positional relationship, movement status and the like between various components in a specific posture (as shown in the accompanying drawings), and if this specific posture changes, said directional indications also change accordingly.

### Embodiment I

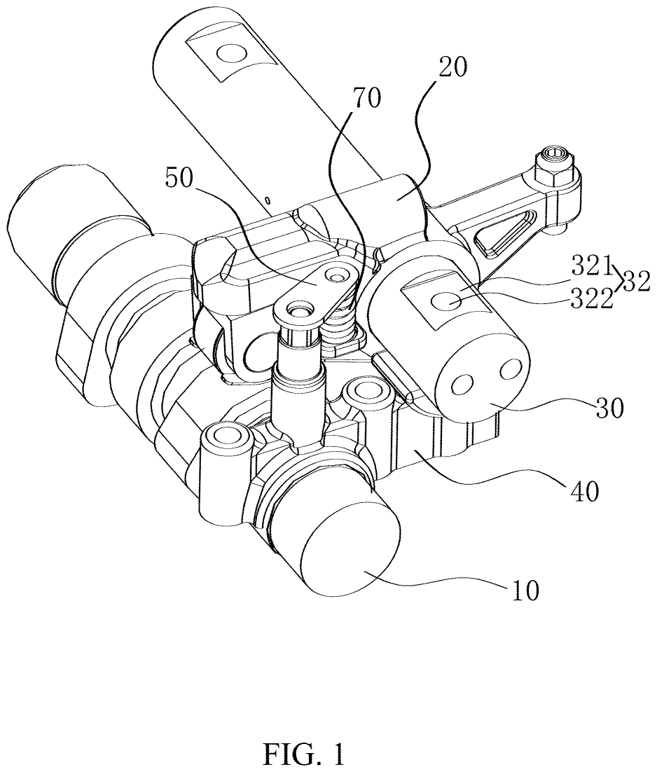

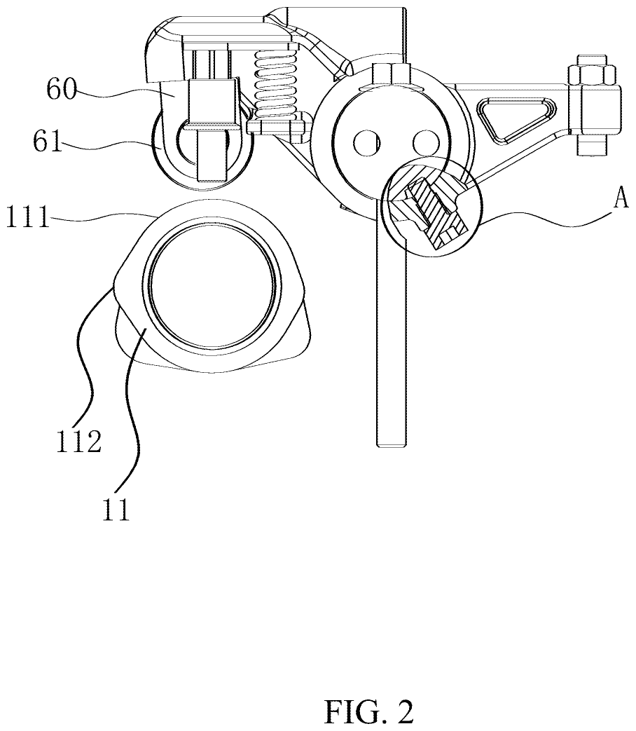

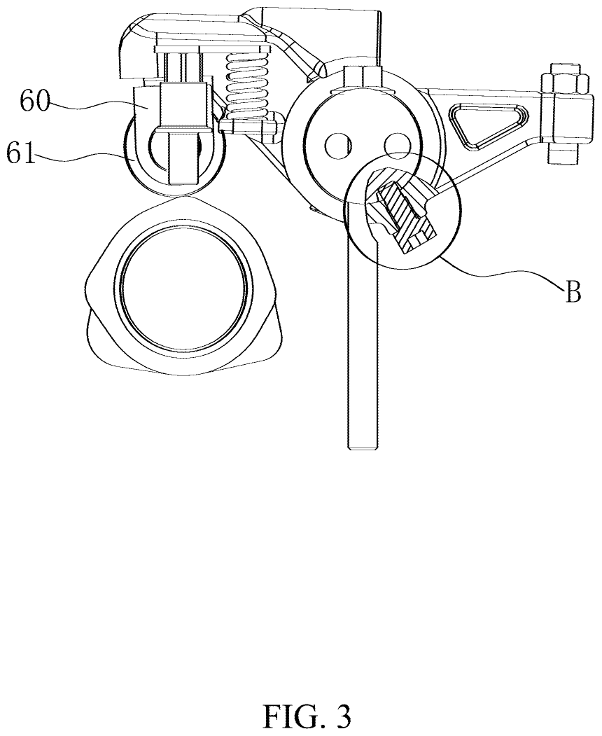

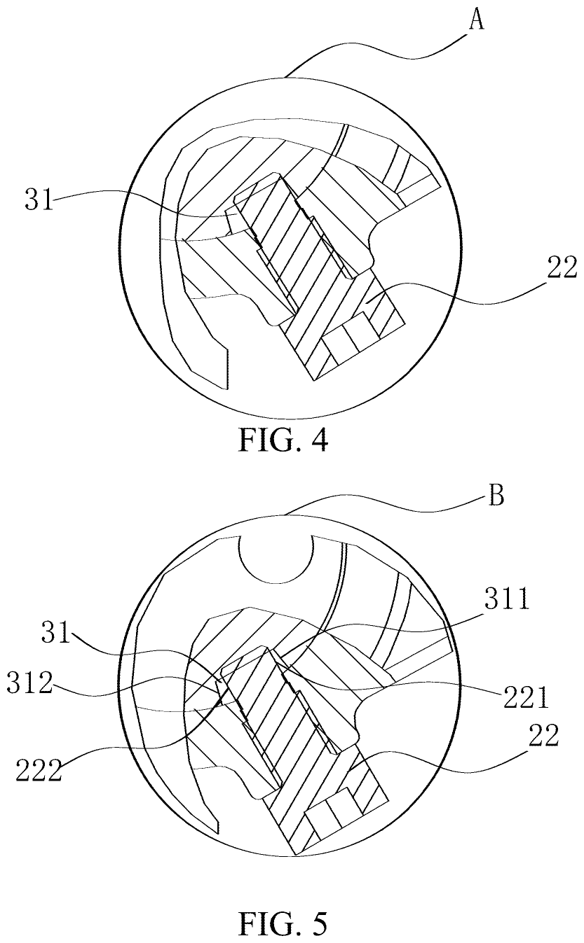

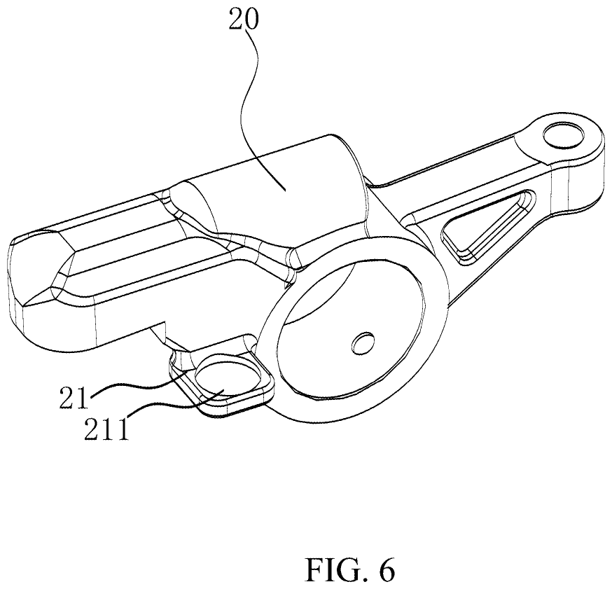

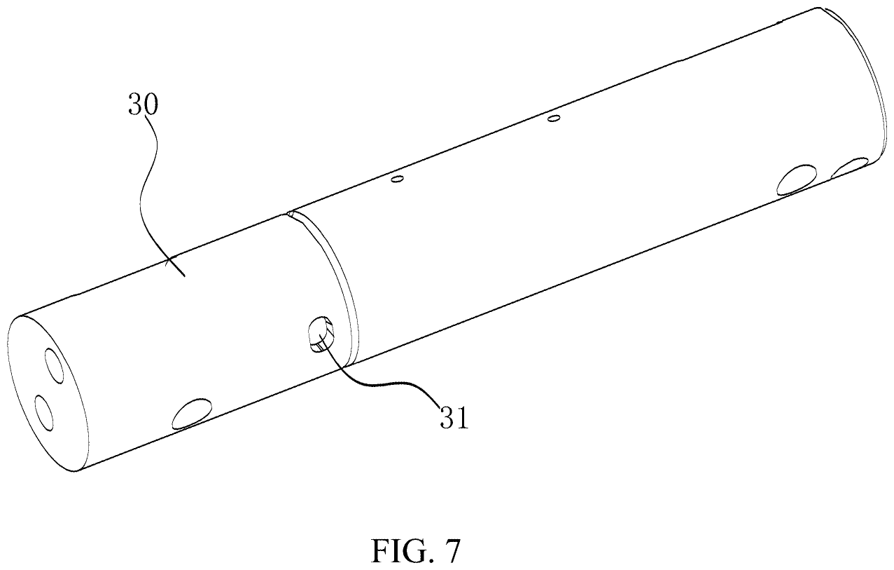

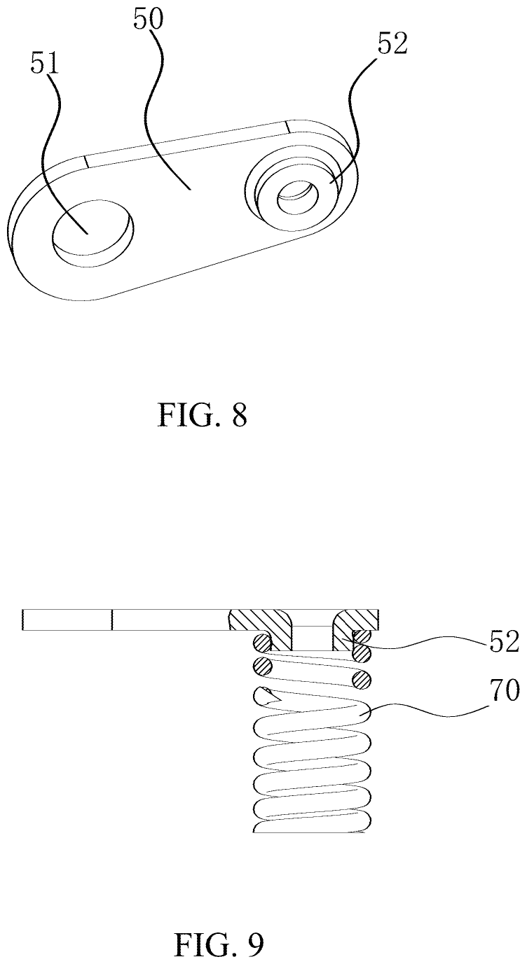

As shown in FIGS. 1 to 9, the present invention provides an engine braking device with returning and limiting functions. The engine braking device includes: a camshaft 10, a brake rocker arm 20, a rocker arm shaft 30, a rocker arm support base 40, a return spring bracket 50, a slidable unit 60, and a first elastic member 70.

The camshaft 10 includes an auxiliary cam 11, and an outer contour of the auxiliary cam 11 is provided with a non-working surface 111 and a working surface 112. Here, a distance between the working surface 112 and a base circle center of the auxiliary cam 11 is greater than a distance between the non-working surface 111 and the base circle center of the auxiliary cam 11.

The brake rocker arm 20 and the rocker arm shaft 30 mate via a shaft hole, the brake rocker arm 20 is swingable back and forth around the rocker arm shaft 30, and an axis direction of the rocker arm shaft 30 and an axis direction of the camshaft 10 are parallel to each other. Here, a lateral portion of the brake rocker arm 20 extends in a horizontal direction to form a butting platform 21, an outer surface of the rocker arm shaft 30 is provided with a limiting recess 31, and both sides of the limiting recess 31 are provided with a first butting surface A 311 and a first butting surface B 312, respectively. The brake rocker arm 20 is provided with a limiting protrusion 22 in concave-convex mating with the limiting recess 31, both sides of the limiting protrusion 22 are provided with a second butting surface A 221 and a second butting surface B 222, respectively, and a relative distance between the second butting surface A 221 and the second butting surface B 222 is less than a relative distance between the first butting surface A 311 and the first butting surface B 312.

Both ends of the rocker arm support base 40 are mated with a shaft hole of the camshaft 10 and the shaft hole of the rocker arm shaft 30, respectively, and an end of the rocker arm support base 40 mated with the shaft hole of the camshaft 10 is provided with a first connecting portion 41.

The return spring bracket 50 has an end connected to the first connecting portion 41 via a fastener or connected to a second connecting portion 32 on the rocker arm shaft 30. Here, a horizontal height of the first connecting portion 41 and a horizontal height of the second connecting portion 32 are both higher than a horizontal height of the butting platform 21, and a horizontal height of the return spring bracket 50 is lower than a horizontal height of an upper surface of the brake rocker arm 20.

The slidable unit 60 is slidably connected to an end of the brake rocker arm 20 corresponding to the auxiliary cam 11, and the slidable unit 60 is provided with a wheel 61. Here, an axis direction of the wheel 61 and the axis direction of the camshaft 10 are parallel to each other.

Both ends of the first elastic member 70 are sandwiched between the other end of the return spring bracket 50 and the butting platform 21, and an extension direction of the first elastic member 70 is parallel to a connecting line between the circle center of the auxiliary cam 11 and the circle center of the wheel 61. Here, an axis of the first elastic member 70 is biased to the side of the connecting line between the circle center of the auxiliary cam 11 and the circle center of the wheel 61, and the first elastic member 70 is located between the wheel 61 and the rocker arm shaft 30.

Here, when an engine works normally, a gap exists between the wheel 61 and the working surface 112 of the auxiliary cam 11, the first butting surface A 311 and the second butting surface A 221 butt against each other, and the first elastic member 70 is in an energy storage state.

When the engine is braked during working, the wheel 61 contacts the outer contour of the auxiliary cam 11, and as the working surface 112 and the non-working surface 111 on the auxiliary cam 11 alternately contact the wheel 61, the brake rocker arm 20 is caused to swing back and forth around the rocker arm shaft 30, and the limiting protrusion 22 is caused to swing back and forth inside the limiting recess 31.

The present invention provides an engine braking device with returning and limiting functions, the overall size of which is reduced in a vertical direction, resulting in a compacter structure. In addition, the concave-convex mating between the limiting protrusion 22 and the limiting recess 31 reduces frictional work and engine fuel consumption by preventing the wheel 61 from contacting the auxiliary cam 11 when the engine works normally, and also enables controlling of the amplitude of back-and-forth swing of the brake rocker arm 20 when the engine is in a braked stage, achieving an improved braking effect.

It should be further noted that a position for the concave-convex mating between the limiting recess 31 and the limiting protrusion 22 is on a right half side of the rocker arm shaft 30. Here, an extension line of an axis of the limiting protrusion 22 passes through a circle center of a cross section of the rocker arm shaft 30 where the limiting protrusion 22 is located.

Preferably, the limiting recess 31 is a limiting hole, the limiting protrusion 22 is a limiting pin threaded to the brake rocker arm 20, and an end of the limiting pin passes through the limiting hole and extends into the rocker arm shaft 30. Here, an aperture of the limiting hole is greater than a diameter of the end of the limiting pin in inserted mating with the limiting hole, and the first butting surface A 311, the first butting surface B 312, the second butting surface A 221 and the second butting surface B 222 are each provided in form of an arc-shaped surface.

It's worth noting that, when the engine works normally, the first butting surface A 311 and the second butting surface A 221 butt against each other, at which point the first elastic member 70 is in an energy storage state, and the wheel 61 does not contact the working surface 112 of the auxiliary cam 11 under the action of the slidable unit 60. When the engine is in a braked state, the wheel 61 extends to contact the outer contour of the auxiliary cam 11 under the action of the slidable unit 60, and the butting between the first butting surface A 311 and the second butting surface A 221 is released; as the wheel 61 alternately passes the working surface 112 and the non-working surface 111 on the auxiliary cam 11, the limiting protrusion 22 swings back and forth inside the limiting recess 31, and during the back-and-forth swinging of the limiting protrusion 22, the first butting surface A 311 does not contact the second butting surface A 221, and the first butting surface B 312 does not contact the second butting surface B 222; and when the engine returns to normal working after completing braking, the wheel 61 retracts under the action of the slidable unit 60 to form a gap again with the working surface 112 of the auxiliary cam 11, and at the same, the first butting surface A 311 and the second butting surface A 221 butt against each other again.

Preferably, the return spring bracket 50 is provided in a plate-like form, one end of the return spring bracket 50 is provided with a first mounting hole 51 that is in inserted mating with the fastener and serves to mount the return spring bracket 50 on the rocker arm support base 40, and the other end of the return spring bracket 50 is provided with a boss 52. Here, interference nested fit is formed between the boss 52 and the first elastic member 70, and an end of the first elastic member 70 mating the boss 52 butts against a surface of the return spring bracket 50.

In this embodiment, the boss 52 on the return spring bracket 50 is generally formed by pull riveting, by which the boss 52 formed is elastic and allows for tensioning the first elastic member 70 to complete the interference connection between the return spring bracket 50 and the first elastic member 70 and prevent the two from separation, such that the reliability of the connection between the return spring bracket 50 and the first elastic member 70 is improved.

It's worth noting that the end of the return spring bracket 50 provided with the first mounting hole 51 can be similarly connected onto the rocker arm shaft 30, and the horizontal height of the connection between the return spring bracket 50 and the rocker arm shaft 30 is similarly higher than the horizontal height of the butting platform 21.

Preferably, the first connecting portion 41 includes a connecting column 411, and a connecting hole 412 is provided in the connecting column 411. Here, the first mounting hole 51 in the return spring bracket 50 and the connecting hole 412 are connected to each other via a fastener.

Preferably, the second connecting portion 32 includes a first mounting plane 321 that is formed by downwards sinking a side of the rocker arm shaft 30 facing the return spring bracket 50, and a horizontal height of the first mounting plane 321 is higher than the horizontal height of the butting platform 21. Here, the first mounting plane 321 is provided with a second mounting hole 322 connected to the return spring bracket 50.

It's worth noting that the first mounting plane 321 arranged on the rocker arm shaft 30 serves to connect the return spring bracket 50 and is formed by downwards sinking the arc-shaped surface of the rocker arm shaft 30, such that, when one end of the return spring bracket 50 is connected to the rocker arm shaft 30, the position of the return spring bracket 50 on the first mounting plane 321 can be controlled and fixed to prevent the return spring bracket 50 and the rocker arm shaft 30 from relative slippage during their connection, thereby improving the reliability of the connection between the return spring bracket 50 is connected to the rocker arm shaft 30.

It should be further noted that both ends of the rocker arm shaft 30 in the axis direction thereof are each provided with a first mounting plane 321, and the first mounting planes 321 at both ends of the rocker arm shaft 30 are at the same horizontal plane.

In this embodiment, the arrangement of one first mounting plane 321 on each end of the rocker arm shaft 30 is intended to enable foolproof installation of the rocker arm shaft 30. It's worth noting that the similar arrangement of one limiting recess 31 on each end of the rocker arm shaft 30 enables “symmetric arrangement” of the rocker arm shaft 30 in a true sense, ensuring the assembly efficiency for the engine braking device.

Preferably, the butting platform 21 is provided with a positioning portion 211, which is in nested fit with the first elastic member 70 and by which a radial degree of freedom of the first elastic member 70 is defined. Here, the positioning portion 211 is a concave cavity or a positioning projection; when the positioning portion 211 is the concave cavity, an end of the first elastic member 70 is nested in the concave cavity and butts against a bottom of the concave cavity; and when the positioning portion 211 is the positioning projection, an end of the first elastic member 70 is nested in the positioning projection and butts against a surface of the butting platform 21.

It's worth noting that the positioning portion 211 arranged on the butting platform 21 serves to keep the elastic member 70 always moving along its axis direction during its extension or compression process, without twisting or deviation.

In addition, the arrangement of the positioning portion 211 on the butting platform 21 is intended to reduce assembly parts and improve the assembly efficiency. Most preferably, the positioning portion 211 is directly integrated to the butting platform 21. Therefore, the positioning portion 21 may be selected as a concave cavity, or a positioning projection. Here, the concave cavity refers to a cavity with an opening flush with the upper surface of the butting platform 21 and with a bottom lower than the upper surface of the butting platform 21. The positioning projection refers to a step with a bottom flush with the upper surface of the butting platform 21 and with a top higher than the upper surface of the butting platform 21. When the positioning portion 211 is the concave cavity, the first elastic member 70 is inserted into the positioning portion 211; and when the positioning portion 211 is the positioning projection, the positioning portion 211 is inserted into the first elastic member 70.

Therefore, in order to increase the contact area between the positioning portion 211 and the first elastic member 70, the positioning portion 211 is generally provided in a circular form. The first elastic member 70 here is a columnar spring, which is also generally provided in a circular form.

It should be further noted that the positioning portion 211 is not limited to the integral molding on the butting platform 21 only, but also can be mounted on the butting platform 21 by means of a structure to achieve the effect of positioning the first elastic member 70.

### Embodiment II

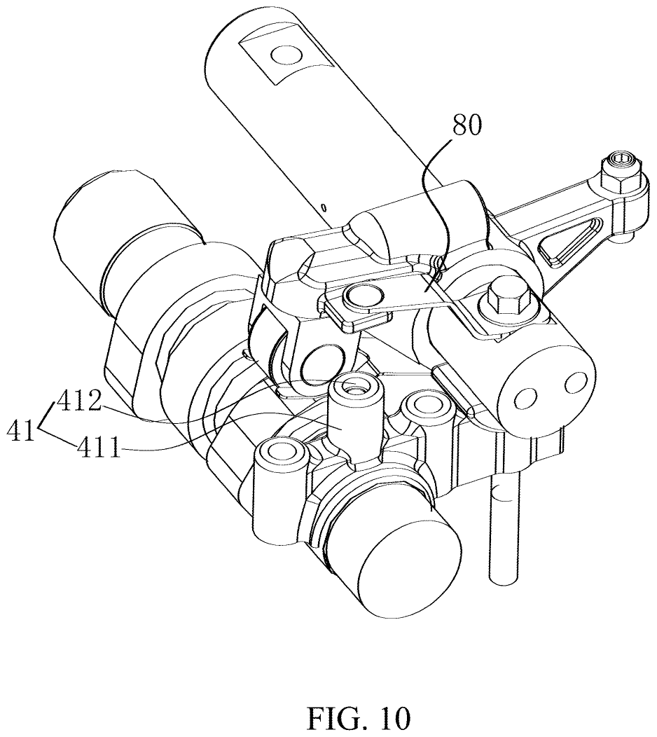

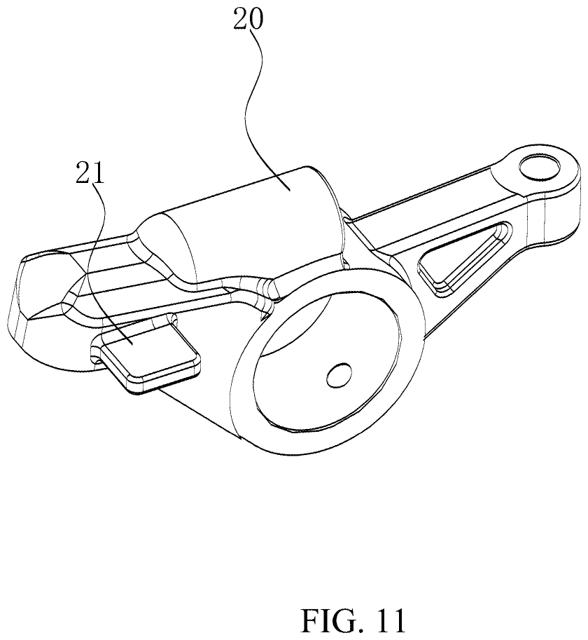

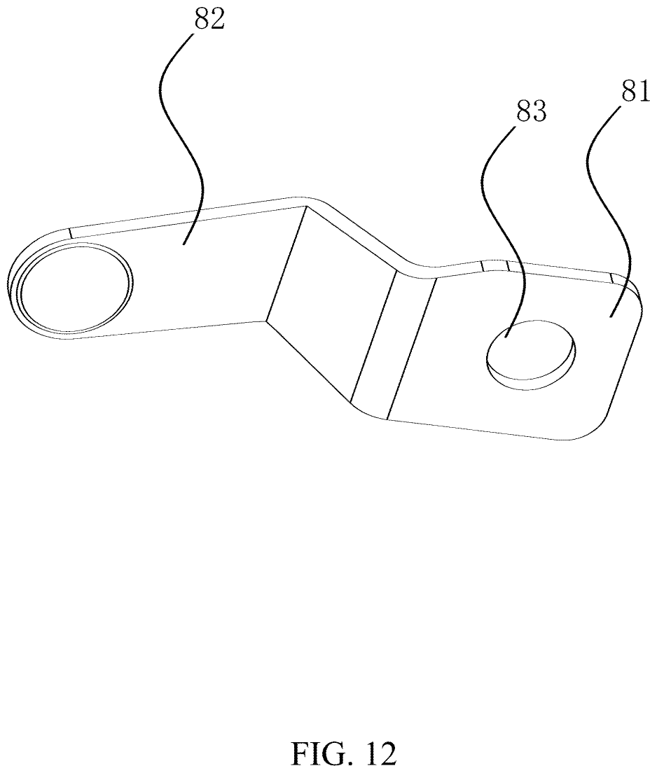

As shown in FIGS. 1 to 12, this embodiment differs from Embodiment I in that: the first elastic member 70 in Embodiment I is a columnar elastic member, and the second elastic member 80 in this embodiment is a plate-like elastic member. Therefore, for the mounting of the columnar elastic member in Embodiment I, it is clearly indicated that a return spring bracket 50 is additionally arranged, and the return spring bracket 50 has an end connected to the first connecting portion 41 via a fastener or connected to the second connecting portion 32 on the rocker arm shaft 30. Here, the horizontal height of the first connecting portion 41 and the horizontal height of the second connecting portion 32 are both higher than the horizontal height of the butting platform 21, and the horizontal height of the return spring bracket 50 is lower than the horizontal height of the upper surface of the brake rocker arm 20.

This embodiment, however, is devoid of the return spring bracket 50. Therefore, for the mounting of the plate-like elastic member, it is clearly indicated that the second elastic member 80 has an end connected to the first connecting portion 41 via a fastener or connected to a second connecting portion 32 on the rocker arm shaft 30. Here, the horizontal height of the first connecting portion 41 and the horizontal height of the second connecting portion 32 are both lower than the horizontal height of the butting platform 21, and the horizontal height of an end of the second elastic member 80 butting against the butting platform 21 is lower than the horizontal height of the upper surface of the brake rocker arm 20.

It's worth noting that, when the first elastic member 70 is a columnar elastic member, the horizontal height of the first connecting portion 41 and the horizontal height of the second connecting portion 32 are both higher than the horizontal height of the butting platform 21; and when the second elastic member 80 is a plate-like elastic member, the horizontal height of the first connecting portion 41 and the horizontal height of the second connecting portion 32 are both lower than the horizontal height of the butting platform 21.

Whether it is the engine braking device in Embodiment I or the engine braking device in Embodiment II, both are reduced in size in a vertical direction, allowing for achieving a compacter structure.

It should be further noted that the second elastic member 80 is provided in form of a Z-shaped plate, and both ends of the second elastic member 80 include a first connecting end 81 and a second connecting end 82, respectively. Here, the first connecting end 81 and the second mounting plane on the rocker arm shaft 30 are in face-to-face contact, and are connected and fixed via a fastener, and the second connecting end 82 and the butting platform 21 are in face-to-face contact. Here, the second mounting plane is provided with a fourth mounting hole.

In this embodiment, the second elastic member 80 is provided in form of a plate-like structure in such a manner that the second elastic member 80 is in face-to-face contact with both the butting platform 21 and the second mounting plane. In this way, the contact area is increased, resulting in improved connection firmness and service reliability of the second elastic member 80.

It should be further noted that the second mounting plane and the fourth mounting hole in the second mounting plane are structurally the same as the first mounting plane 321 and the second mounting hole 322 in the first mounting plane 321. Here, the second elastic member 80 is provided with third mounting hole 83 connected to the fourth mounting hole.

It should be further noted that, in addition to the direct face-to-face contact between the butting platform 21 and the second connecting end 82 of the second elastic member 80, it is also possible that the butting platform 21 is provided with a positioning protrusion or recess, and the second connecting end 82 of the second elastic member 80 is provided with a corresponding positioning recess or protrusion. Here, relative slippage between the butting platform 21 and the second connecting end 82 of the second elastic member 80 is defined by means of concave-convex mating between the positioning protrusion and the positioning recess.

It's worth noting that the effect achieved by arranging the positioning protrusion and the positioning recess on the butting platform 21 and the second elastic member 80 is the same as that achieved by arranging the positioning portion 211 in Embodiment I, and thus, the details will not be repeated here.

It should be noted that, in the present invention, the description involving “first”, “second”, “a/an” or the like is for a descriptive purpose only and should not be understood as indicating or suggesting relative importance or implying the clear designation of the number of technical features as indicated. As such, a feature defined by “first” or “second” may expressly or implicitly indicate the inclusion of at least such feature. In the description of the present invention, the meaning of “a plurality of” indicates at least two, for example, two, three, etc., unless otherwise explicitly specified. The terms “connection”, “fixation” and the like should be understood in a broad sense. For example, “fixation” may indicate a fixed connection, or a detachable connection, or an integral connection; or a mechanical connection, or an electric connection; or a direct connection , an indirect connection via an intermediate medium, or internal communication or interaction between two elements, unless otherwise explicitly specified. For those of ordinary skill in the art, the specific meanings of the above terms in the present invention can be understood based on specific situations.

In addition, the technical solutions of individual embodiments of the present invention can be combined with each other, which, however, must be based on the potential of implementation by those of ordinary skill in the art. When mutual contradiction or failed implementation occurs during the combination of the technical solutions, it should be considered that such a combination of the technical solutions does not exist and is not within the protection scope claimed by the present invention.

The specific embodiments described herein are only examples to illustrate the spirit of the present invention. Those skilled in the art to which the present invention belongs can make various modifications or additions to the described specific embodiments or adopt similar methods for substitution, all of which do not deviate from the spirit of the present invention or exceed the scope defined by the appended claims.

What is claimed is:

1. An engine braking device with returning and limiting functions, comprising:
a camshaft comprising an auxiliary cam, an outer contour of the auxiliary cam being provided with a non-working surface and a working surface, wherein a distance between the working surface and a base circle center of the auxiliary cam is greater than a distance between the non-working surface and the base circle center of the auxiliary cam;
a brake rocker arm and a rocker arm shaft that mate via a shaft hole, the brake rocker arm being swingable back and forth around the rocker arm shaft, and an axis direction of the rocker arm shaft and an axis direction of the camshaft being parallel to each other, wherein a lateral portion of the brake rocker arm extends in a horizontal direction to form a butting platform, an outer surface of the rocker arm shaft is provided with a limiting recess, both sides of the limiting recess are provided with a first butting surface A and a first butting surface B, respectively, the brake rocker arm is provided with a limiting protrusion in concave-convex mating with the limiting recess, both sides of the limiting protrusion are provided with a second butting surface A and a second butting surface B, respectively, and a relative distance between the second butting surface A and the second butting surface B is less than a relative distance between the first butting surface A and the first butting surface B;
a rocker arm support base, wherein both ends of the rocker arm support base are mated with a shaft hole of the camshaft and the shaft hole of the rocker arm shaft, respectively, and an end of the rocker arm support base mated with the shaft hole of the camshaft is provided with a first connecting portion;
a return spring bracket with an end connected to the first connecting portion via a fastener or connected to a second connecting portion on the rocker arm shaft, wherein a horizontal height of the first connecting portion and a horizontal height of the second connecting portion are both higher than a horizontal height of the butting platform, and a horizontal height of the return spring bracket is lower than a horizontal height of an upper surface of the brake rocker arm;
a slidable unit slidably connected to an end of the brake rocker arm corresponding to the auxiliary cam, the slidable unit being provided with a wheel, wherein an axis direction of the wheel and the axis direction of the camshaft are parallel to each other; and
a first elastic member with both ends sandwiched between the other end of the return spring bracket and the butting platform, wherein an axis of the first elastic member is biased to a side of a connecting line between a circle center of the auxiliary cam and a circle center of the wheel, and the first elastic member is located between the wheel and the rocker arm shaft;
wherein when an engine works normally, a gap exists between the wheel and the working surface of the auxiliary cam, the first butting surface A and the second butting surface A butt against each other, and the first elastic member is in an energy storage state; and
when the engine is in a braked state, the wheel contacts the outer contour of the auxiliary cam, and as the working surface and the non-working surface on the auxiliary cam alternately contact the wheel, the brake rocker arm is caused to swing back and forth around the rocker arm shaft, and the limiting protrusion is caused to swing back and forth inside the limiting recess.

2. The engine braking device with returning and limiting functions according to claim 1, wherein a position for the concave-convex mating between the limiting recess and the limiting protrusion is on a right half side of the rocker arm shaft, and wherein an extension line of an axis of the limiting protrusion passes through a circle center of a cross section of the rocker arm shaft where the limiting protrusion is located.

3. The engine braking device with returning and limiting functions according to claim 1, wherein the limiting recess is a limiting hole, the limiting protrusion is a limiting pin threaded to the brake rocker arm, and an end of the limiting pin passes through the limiting hole and extends into the rocker arm shaft, wherein an aperture of the limiting hole is greater than a diameter of the end of the limiting pin in inserted mating with the limiting hole, and the first butting surface A, the first butting surface B, the second butting surface A and the second butting surface B are each provided in form of an arc-shaped surface.

4. The engine braking device with returning and limiting functions according to claim 1, wherein the return spring bracket is provided in a plate-like form, one end of the return spring bracket is provided with a first mounting hole that is in inserted mating with the fastener and serves to mount the return spring bracket on the rocker arm support base, and the other end of the return spring bracket is provided with a boss, wherein interference nested fit is formed between the boss and the first elastic member, and an end of the first elastic member mating the boss butts against a surface of the return spring bracket.

5. The engine braking device with returning and limiting functions according to claim 1, wherein the return spring bracket is provided in a plate-like form, one end of the return spring bracket is provided with a first mounting hole that is in inserted mating with the fastener and serves to mount the return spring bracket on the rocker arm shaft, and the other end of the return spring bracket is provided with a boss, wherein interference nested fit is formed between the boss and the first elastic member, and an end of the first elastic member mating the boss butts against a surface of the return spring bracket.

6. The engine braking device with returning and limiting functions according to claim 1, wherein the first connecting portion comprises a connecting column, and a connecting hole is provided in the connecting column, wherein the first mounting hole in the return spring bracket and the connecting hole are connected to each other via a fastener.

7. The engine braking device with returning and limiting functions according to claim 1, wherein the second connecting portion comprises a first mounting plane that is formed by downwards sinking a side of the rocker arm shaft facing the return spring bracket, and a horizontal height of the first mounting plane is higher than a horizontal height of the butting platform, wherein the first mounting plane is provided with a second mounting hole connected to the return spring bracket.

8. The engine braking device with returning and limiting functions according to claim 7, wherein both ends of the rocker arm shaft in the axis direction thereof are each provided with a first mounting plane, and the first mounting planes at both ends of the rocker arm shaft are at the same horizontal plane.

9. The engine braking device with returning and limiting functions according to claim 1, wherein the butting platform is provided with a positioning portion, which is in nested fit with the first elastic member and by which a radial degree of freedom of the first elastic member is defined, wherein the positioning portion is a concave cavity or a positioning projection; when the positioning portion is the concave cavity, an end of the first elastic member is nested in the concave cavity and butts against a bottom of the concave cavity; and when the positioning portion is the positioning projection, an end of the first elastic member is nested in the positioning projection and butts against a surface of the butting platform.

10. An engine braking device with returning and limiting functions, comprising:
a camshaft comprising an auxiliary cam, an outer contour of the auxiliary cam being provided with a non-working surface and a working surface, wherein a distance between the working surface and a base circle center of the auxiliary cam is greater than a distance between the non-working surface and the base circle center of the auxiliary cam;
a brake rocker arm and a rocker arm shaft that mate via a shaft hole, the brake rocker arm being swingable back and forth around the rocker arm shaft, and an axis direction of the rocker arm shaft and an axis direction of the camshaft being parallel to each other, wherein a lateral portion of the brake rocker arm extends in a horizontal direction to form a butting platform, an outer surface of the rocker arm shaft is provided with a limiting recess, both sides of the limiting recess are provided with a first butting surface A and a first butting surface B, respectively, the brake rocker arm is provided with a limiting protrusion in concave-convex mating with the limiting recess, both sides of the limiting protrusion are provided with a second butting surface A and a second butting surface B, respectively, and a relative distance between the second butting surface A and the second butting surface B is less than a relative distance between the first butting surface A and the first butting surface B;
a rocker arm support base, wherein both ends of the rocker arm support base are mated with a shaft hole of the camshaft and the shaft hole of the rocker arm shaft, respectively, and an end of the rocker arm support base mated with the shaft hole of the camshaft is provided with a first connecting portion;
a second elastic member with an end connected to the first connecting portion via a fastener or connected to a second connecting portion on the rocker arm shaft, wherein a horizontal height of the first connecting portion and a horizontal height of the second connecting portion are both lower than a horizontal height of the butting platform, and a horizontal height of an end of the second elastic member butting against the butting platform is lower than a horizontal height of an upper surface of the brake rocker arm;
a slidable unit slidably connected to an end of the brake rocker arm corresponding to the auxiliary cam, the slidable unit being provided with a wheel, wherein an axis direction of the wheel and the axis direction of the camshaft are parallel to each other; and
wherein when an engine works normally, a gap exists between the wheel and the working surface of the auxiliary cam, the first butting surface A and the second butting surface A butt against each other, and the second elastic member is in a deformation state; and
when the engine is in a braked state, the wheel contacts the outer contour of the auxiliary cam, and as the working surface and the non-working surface on the auxiliary cam alternately contact the wheel, the brake rocker arm is caused to swing back and forth around the rocker arm shaft, and the limiting protrusion is caused to swing back and forth inside the limiting recess.

11. The engine braking device with returning and limiting functions according to claim 10, wherein the second elastic member is provided in form of a Z-shaped plate, and both ends of the second elastic member comprise a first connecting end and a second connecting end, respectively, wherein the first connecting end and the rocker arm shaft are in face-to-face contact, and are connected and fixed via a fastener, and the second connecting end and the butting platform are in face-to-face contact.

12. The engine braking device with returning and limiting functions according to claim 11, wherein the butting platform is provided with a positioning protrusion or recess, and the second connecting end of the second elastic member is provided with a corresponding positioning recess or protrusion, wherein relative slippage between the butting platform and the second connecting end of the second elastic member is defined by means of concave-convex mating between the positioning protrusion and the positioning recess.

13. The engine braking device with returning and limiting functions according to claim 10, wherein the first connecting portion comprises a connecting column, and a connecting hole is provided in the connecting column, wherein a third mounting hole in the second elastic member and the connecting hole are connected to each other via a fastener.

14. The engine braking device with returning and limiting functions according to claim 10, wherein the second connecting portion comprises a second mounting plane that is formed by downwards sinking a side of the rocker arm shaft facing the second elastic member, and a horizontal height of the second mounting plane is lower than a horizontal height of the butting platform, wherein the second mounting plane is provided with a fourth mounting hole connected to the second elastic member.

15. The engine braking device with returning and limiting functions according to claim 14, wherein both ends of the rocker arm shaft in the axis direction thereof are each provided with a second mounting plane, and the second mounting planes at both ends of the rocker arm shaft are at the same horizontal plane.

16. An engine, comprising the engine braking device with returning and limiting functions according to claim 1.

17. An engine, comprising the engine braking device with returning and limiting functions according to claim 10.
